(19) United States
(12) Patent Application Publication
(10) Pub. No.: US 2018/0293650 A1
(43) Pub. Date: Oct. 11, 2018

(54) CREATION, TRADING, AND MANAGEMENT OF IMPACT SECURITIES

(71) Applicant: NPX, Inc., San Francisco, CA (US)

(72) Inventor: Lindsay BECK, San Francisco, CA (US)

(73) Assignee: NPX, Inc., San Francisco, CA (US)

(21) Appl. No.: 15/950,986

(22) Filed: Apr. 11, 2018

Related U.S. Application Data
(60) Provisional application No. 62/484,253, filed on Apr. 11, 2017.

(51) Int. Cl. G06Q 40/04; G06Q 40/06; G06Q 30/02

(52) U.S. Cl. CPC G06Q 40/04; G06Q 30/0205; G06Q 30/0201; G06Q 40/06

(57) ABSTRACT

The present aspects relate to issuance and management of impact securities. Specifically, in some aspects, an impact security issuer may generate and issue an impact security to one or more entities. The impact security issuer may periodically receive measurable impact data to compare against a threshold set of data. Accordingly, the impact security issuer may provide a monetary amount to an investor based on determining that a change agent entity satisfies the threshold set of data.

### CROSS-REFERENCE TO RELATED APPLICATION

This application claims the benefit of U.S. Provisional Application No. 62/484,253, filed on Apr. 11, 2017, the entire contents of which is incorporated herein by reference.

### FIELD OF THE INVENTION

The present aspects generally relate to investment vehicles, and more particularly, to the creation, trading, and management of impact securities.

### BACKGROUND OF THE INVENTION

Various organizations, such as nonprofit organizations, rely on charitable contributions as their primary funding source. As a result, these organizations raise money in an inefficient private marketplace. As a result of market inefficiencies, the cost of capital for such organizations is comparably higher than other (e.g., for-profit) organizations or entities. Further, the high cost of capital is prohibiting effective organizations from sufficiently scaling various high-impact programs intended to solve social problems. Thus, it would be desirable to address the foregoing deficiencies and facilitate an efficient market for securities related to solving social problems.

### SUMMARY OF THE INVENTION

The present aspects include a method, comprising: at an issuing device including one or more processing components: generating an impact security, wherein the impact security includes a first set of metric factors; receiving an acquisition request to acquire the impact security from an investor device; transferring the impact security to one or both of the investor device or a change agent entity in response to receiving the request to acquire the impact security by the investor device; receiving a second set of metric factors associated with the impact security from a third party researcher device; determining whether the second set of metric factors satisfy the first set of metric factors; and transferring a predefined monetary value from the issuer device to the investor device based on a determination that the second set of metric factors meets or exceeds the first set of metric factors.

The present aspects further include an electronic device, comprising: one or more processors; memory; one or more programs stored in memory, the one or more programs including instructions for: generating an impact security, wherein the impact security includes a first set of metric factors; receiving an acquisition request to acquire the impact security from an investor device; transferring the impact security to one or both of the investor device or a change agent entity in response to receiving the request to acquire the impact security by the investor device; receiving a second set of metric factors associated with the impact security from a third party researcher device; determining whether the second set of metric factors satisfy the first set of metric factors; and transferring a predefined monetary value from the issuer device to the investor device based on a determination that the second set of metric factors meets or exceeds the first set of metric factors.

The present aspects additionally include a computer-readable storage medium comprising one or more programs for execution by one or more processors of an electronic device, the one or more programs including instructions which, when executed by the one or more processors, cause the electronic device to: generate an impact security, wherein the impact security includes a first set of metric factors; receive an acquisition request to acquire the impact security from an investor device; transfer the impact security to one or both of the investor device or a change agent entity in response to receiving the request to acquire the impact security by the investor device; receive a second set of metric factors associated with the impact security from a third party researcher device; determine whether the second set of metric factors satisfy the first set of metric factors; and transfer a predefined monetary value from the issuer device to the investor device based on a determination that the second set of metric factors meets or exceeds the first set of metric factors.

Further features and advantages of the invention, as well as the structure and operation of various aspects of the invention, are described in detail below with reference to the accompanying drawings. It is noted that the invention is not limited to the specific aspects described herein. Such aspects are presented herein for illustrative purposes only. Additional aspects will be apparent to persons skilled in the relevant art(s) based on the teachings contained herein.

### BRIEF DESCRIPTION OF THE DRAWINGS

The accompanying drawings, which are incorporated herein and form a part of the specification, illustrate aspects of the present invention and, together with the description, further serve to explain the principles of the invention and to enable a person skilled in the relevant art to make and use the invention.

FIG. 1 is a block diagram illustrating an impact security creation, trading, and management system in accordance with some aspects.

FIG. 2 is a flow diagram of an example process of impact security creation, trading, and management in accordance with some aspects.

FIG. 3 is a flow diagram of a further example process of impact security creation, trading, and management in accordance with some aspects.

FIG. 4 is a diagram of an example computer system in which the present aspects may be implemented.

### DETAILED DESCRIPTION OF THE INVENTION

Aspects of the present invention will now be described with reference to the accompanying drawings. In the drawings, generally, like reference numbers indicate identical or functionally similar elements. Additionally, generally, the left-most digit(s) of a reference number identifies the drawing in which the reference number first appears.

The following detailed description refers to the accompanying drawings that illustrate exemplary aspects consistent with this invention. Other aspects are possible, and modifications can be made to the aspects within the spirit and scope of the invention. Therefore, the detailed description is not meant to limit the invention.

It would be apparent to one of skill in the art that the present invention, as described below, can be implemented in many different aspects of software, hardware, firmware, and/or the entities illustrated in the figures. Any actual software code with the specialized control of hardware to implement the present invention is not limiting of the present invention. Thus, the operational behavior of the present invention will be described with the understanding that modifications and variations of the aspects are possible, and within the scope and spirit of the present invention.

Reference to modules and/or components in this specification and the claims means any combination of hardware or software components for performing the indicated function. A module and/or component need not be a rigidly defined entity, such that several modules and/or components may overlap hardware and software components in functionality. For example, a software module or component may refer to a single line of code within a procedure, the procedure itself being a separate software module or component. One skilled in the relevant arts will understand that the functionality of modules may be defined in accordance with a number of stylistic or performance-optimizing techniques, for example.

The present aspects relate to creation, trading, and management of impact securities. Specifically, the present aspects involve a system for creating and managing a market for contingent-return debt securities issued by, for example, nonprofit 501(c)(3) organizations and government entities, to fund social initiatives administered by nonprofit organizations. In some aspects, these types of securities may be referred to as “impact securities”. Impact investing refers to investments made into organizations (non-profit and for-profit) with the goal of generating both measureable social impact and financial returns for investors. In order to facilitate the creation of, and create, a public market for impact securities, the present aspects facilitate the creation, trading, and management of impact securities at a centralized issuer system.

For example, the present aspects may facilitate the development of a standardized financial instrument in the form of an impact security may be generated and/or formed for impact investments. In some aspects, an impact security may be a bond-like financial instrument having a contingent financial return that is issued by a nonprofit organization or government entity. The financial return on impact securities may be linked to, or otherwise based on, a performance of particular, specified impact outcomes. In some aspects, impact securities may be sold to or otherwise purchased by investors through offerings (e.g., public offerings).

Further, the present aspects include the development of metrics and analytics designed to assess the performance and value of an impact security, in order to provide enhanced transparency to investors and to provide a framework for comparing various impact securities. Such aspect enhances the market for impact securities. In addition, the present aspects include the development of a trading system designed to facilitate transfer and/or transaction of impact securities.

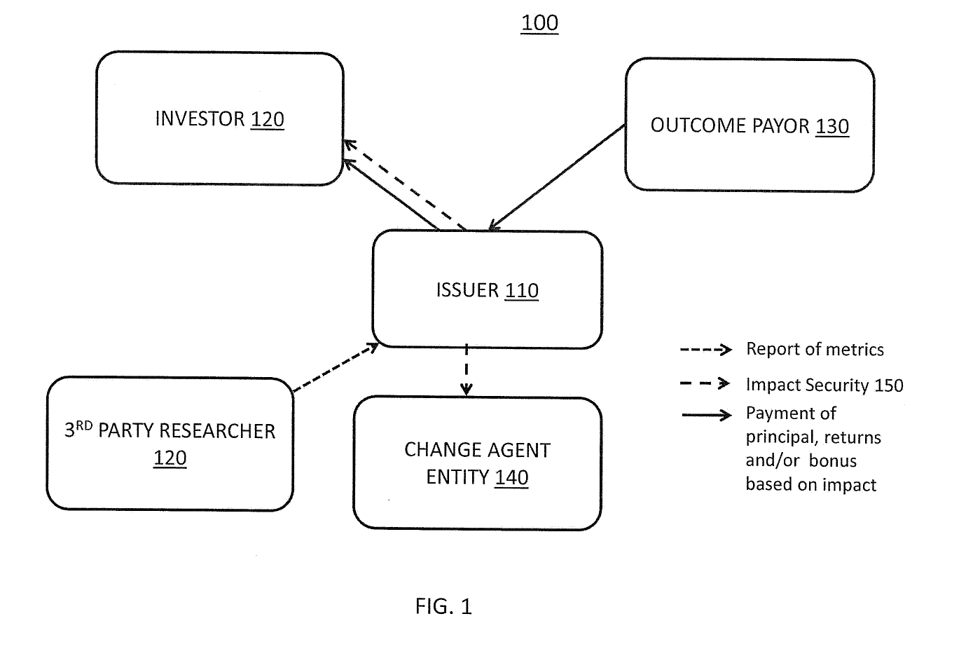

FIG. 1 is a diagram illustrating an impact security creation, trading, and management system 100 in accordance with some aspects. The system 100 may include impact security issuer device 110, which may be configured to create, facilitate trade/transfer of, and management one or more impact securities (e.g., impact security 150). For instance, impact security issuer device 100 may be configured to create or otherwise generate impact security 150. Additionally, impact security issuer device 110 may be in communication with one or more internal/external devices or entities, such as one or more investor devices (e.g., investor device 120), one or more donor devices (e.g., donor device 130), one or more third party researcher devices (e.g., third part researcher device 160), and one or more change agent entities 140. Impact security issuer device 110 may be configured to communicate with each of the foregoing devices/entities as shown in FIG. 1 via a wired and/or wireless connection.

The one or more change agent entities 140 may include first change agent entity 140a, second change agent entity 140b, and third change agent entity 140c, each of which may be configured to receive designated or unique monetary amounts (e.g., investor capital) in exchange for pursuing or undertaking one or more tasks or terms as outlined in the first set of metric factors. In some aspects, change agent entities 140 may be the issuer of the impact security 150 and/or an entity separate from impact security issuer device 110.

In some aspects, impact security 150 may be an investment/financial instrument that is structured as a debt security generated and/or issued by impact security issuer device 110, which, in some instance, may be a 501(c)(3) nonprofit organization or government entity, that incorporates a contingent repayment feature linked to measurable impact results.

In some aspects, impact security 150 may have or otherwise provide a financial return that may be determined based on the measureable impact results of a change agent's social initiative. That is, in some aspects, the impact security 150 includes a first set of metric factors. As such, in order for impact security issuer device 110 to determine whether a change agent entity that has pursued a measurable impact satisfies the desired change or impact, a first set of metric factors are set out and included as part of the issuance of the impact security 150. The return may be transferred to investors by impact security issuer device 110 (e.g., from issuer funds or third-party donations) when, for example, one or more change agents 140 achieve certain impact results specified in the first set of metric factors.

The first set of metric factors included in or as part of the impact security 150 may include an impact topic, a target group, an impact security time duration, a geographic location, an impact direction indication, and an impact number. In some aspects, the impact number may be a percentage value associated with one or more of the target group, the geographic location, or the impact direction indication. It should be understood each of the factors forming the first set of metric factors of impact security 150 may be determined by one or more of impact security issuer device 110, investor device 120, donor device 130, third party researcher device 160, or one or more change agent entities 140.

As a non-limiting example, impact security 150 may include a first set of metric factors related to reducing recidivism in a certain geographic location (e.g., New York City). The impact topic may be recidivism. The target group may be incarcerated males and/or females in the geographic location. Further, the impact security time duration may be a time window during which the one or more change agent entities 140 may attempt to satisfy the first set of metric factors. The impact direction indication may be a decreasing direction set by the impact security 150 (e.g., reducing recidivism). The impact number may be a designated percentage value by which the impact direction indication of the impact topic may be measured (e.g., reducing recidivism in New York City by 25% in 12 months).

In another non-limiting example, impact security 150 may include a first set of metric factors related to increasing literacy in a certain geographic location (e.g., San Francisco). The impact topic may be literacy. The target group may be all children under the age of 12 in the geographic location. Further, the impact security time duration may be a time window (e.g., 24 months) during which the one or more change agent entities 140 may attempt to satisfy the first set of metric factors. The impact direction indication may be an increasing direction set by the impact security 150 (e.g., increased literacy). The impact number may be a designated percentage value by which the impact direction indication of the impact topic may be measured (e.g., increasing literacy in San Francisco by 30% in 24 months).

In some aspects, first set of metric factors may include one or more additional factors including, but not limited to, standardized text/examination scores, cost fading characteristics, and usage rates of certain substances and/or items. Impact security 150 may also include a monetary value corresponding to the first set of metric factors that may be transferred to investor device 120 upon satisfaction of one or more factors of the first set of metric factors. In some aspects, impact security 150 may include one or more monetary values corresponding to various tiers of satisfaction of the first set of metric factors (e.g., tier 1—10% increase in literacy, tier 2—20% increase in literacy, etc.).

In order to determine whether to transfer a monetary value to investor device 120, impact security issuer device 110 may be configured to track or monitor the satisfaction of the first set of metric factors on a periodic basis. Initially, impact security issuer device 110 may be configured to receive an acquisition request from investor device 120 to acquire the impact security 150 having a first set of metric factors. Impact security issuer device 110 may be configured to then transfer the impact security 150 to one or both of investor device 120 or one or more change agent entities 140 responsible for attempting to satisfy or otherwise meet the first set of metric factors.

Within the impact security time period as set forth as a factor in impact security 150, impact security issuer device 110 may receive, at one or more periodic time intervals, a second set of metric factors associated with impact security 150 from one or both of third party researcher device 160 or the one or more change agent entities 140. For example, at a designated time after the generation and/or issuance of impact security 150, impact security issuer device 110 may be configured to request and/or receive a set of measurable factors corresponding to one or more of each of the first set of metric factors (e.g., impact number).

Upon receiving the second set of metric factors, impact security issuer device 110 may be configured to determine whether the second set of metric factors satisfies the first set of metric factors. In particular, impact security issuer device 110 may be configured to determine whether each factor (e.g., geographic location, impact direction indication, impact number, etc.) provided by, for example, third party researcher device 160 satisfies the first or initial set of metric factors established at the time of generation and/or issuance of impact security 150.

Accordingly, impact security issuer device 110 may be configured to transfer, deliver, and/or provide a predefined monetary value from impact security issuer device 110 to investor device 120 based on a determination that the second set of metric factors satisfies the first set of metric factors. Further, impact security issuer device 110 may be configured to forgo transfer of the predefined monetary value to investor device 120 based on a determination that the second set of metric factors does not satisfy the first set of metric factors. Alternatively, impact security issuer device 110 may be configured to transfer of a second predefined monetary value different from the predefined monetary value to investor device 120 based on a determination that the second set of metric factors does not satisfy the first set of metric factors.

In some aspects, the first set of metric factors includes a first impact number corresponding to a threshold percentage value of a target characteristic. Similarly, the second set of metric factors includes a second impact number corresponding to a measured percentage value of the target characteristic. As such, in such aspect, impact security issuer device 110 may be configured to determine whether the second impact number corresponding to the measured percentage value meets or exceeds the first impact number corresponding to the threshold percentage value.

In some aspects, impact security issuer device 110 may be configured to transfer a portion of a predefined monetary amount or value based on the satisfaction of a portion of the first set of metric factors. That is, in aspects where impact security 150 permits apportionment of the predefined monetary amount according to the satisfaction of a number of (e.g., not each and every factor of the first set of metric factors), impact security issuer device 110 may be configured to determine whether a portion of the first set of metric factors has been satisfied, and if so, transfer a portion of the predefined monetary amount/value specified in impact security 150 corresponding to the number of factors met (e.g., transfer is proportional to number of factors met).

In some aspects, impact security issuer device 110 may be configured to transfer or facilitate trading/exchanging of one or more impact securities (e.g., impact security 150). Impact security issuer device 110 may be configured to present or otherwise list one or more impact securities on a display device of each of investor device 120, donor device 130, third party researcher device 160, and/or one or more change agent entities 140. Specifically, impact security issuer device 110 may be configured to provide or present each factor of the first set of metric factors to one or more of the foregoing devices. For example, the first set of metric factors may be standardized terms which may include characteristics that, while optional, may be disclosed by the impact security issuer device 110 issuing impact security 150 (e.g., in some aspects, impact security 150 may not provide interim payments based on the interim results of the underlying social program, but the first set of metric factors may disclose whether it does).

In some aspects, impact security issuer device 110 may be configured to provide data which, upon execution at one or more of investor device 120, donor device 130, third party researcher device 160, and/or one or more change agent entities 140, may be used in rendering a display at each device/entity to display a user interface that facilitates trading/exchanging of one or more impact securities (e.g., impact security 150). For example, impact security issuer device 110 may be configured to provide trade or exchange related data, price data, bid data, a change agent's probability of success of satisfying the first set of metric factors, offer data of one or more impact securities for display, use of proceeds-to-completion percentage ratios data, and return per unit of change data. In some aspects, change agent's probability of success of satisfying the first set of metric factors may be based on the historical performance of the change agent and/or impact security issuer and/or similarly-situated impact securities.

For example, impact security issuer device 110 may be configured to update one or more initial impact security characteristics (e.g., price, bid, and/or offer) of impact security 150 based on receiving the second set of metric factors. In some aspects, the second set of metric factors may be received after the first set of metric factors is established. Additionally, upon or as part of updating the initial impact security characteristics, impact security issuer device 110 may be configured to display or present the associated data for display at one or more of investor device 120, donor device 130, third party researcher device 160, and/or one or more change agent entities 140. As such, one or more parties at each of the aforementioned devices/entities may view up-to-date information regarding each impact security. In some aspects, impact security issuer device 110 may be configured to update and provide the updated impact security characteristics and/or factors on a periodic basis.

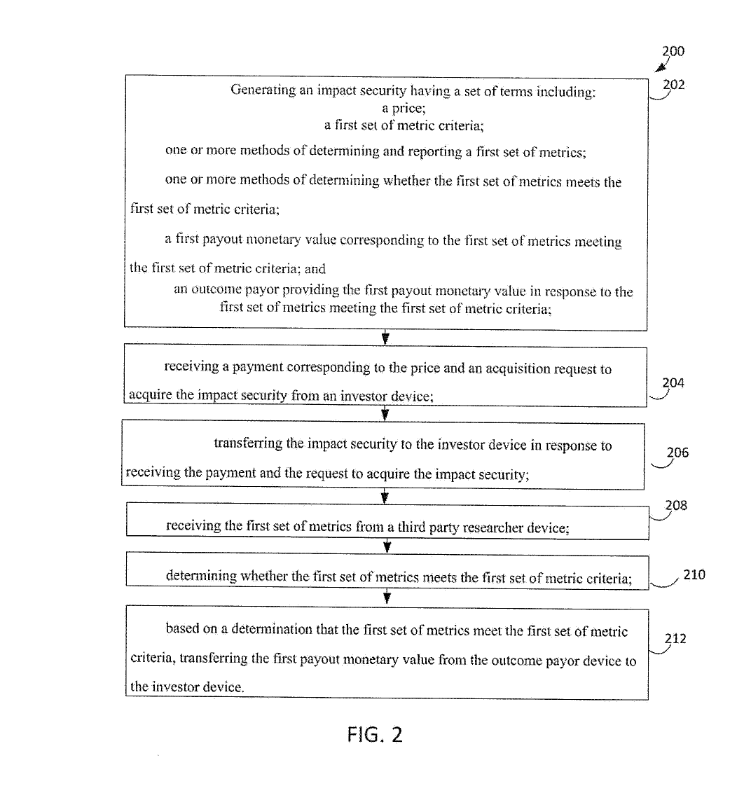

FIG. 2 illustrates example method and/or process 200 of creating, trading, and/or managing an impact security in accordance with the present aspects. In some aspects, method 200 may be executed on or as part of impact security issuer device 110 (FIG. 1), which may include one or more processing components and a database.

At block 202, method 200 may generate an impact security. For example, impact security issuer device 110 (FIG. 1) may be configured to execute an impact security generation component/module to generate an impact security 150 (FIG. 1). In some aspects, the impact security may include a first set of metric factors. In some aspects, the first set of metric factors may include one or more of a target group, a geographic location, an impact direction indication, or an impact number.

At block 204, method 200 may receive an acquisition request to acquire the impact security from an investor device. For instance, impact issuer device 110 (FIG. 1) may be configured to execute a receiving component/module to receive an acquisition request to acquire the impact security 150 (FIG. 1) from an investor device (FIG. 1). Further, at block 206, method 200 may transfer the impact security to one or both of the investor device or a change agent entity. For example, impact security issuer device 110 (FIG. 1) may be configured to execute a security transfer/trading component/module to transfer the impact security 150 (FIG. 1) to one or both of the investor device 120 (FIG. 1) or a change agent entity 140 (FIG. 1).

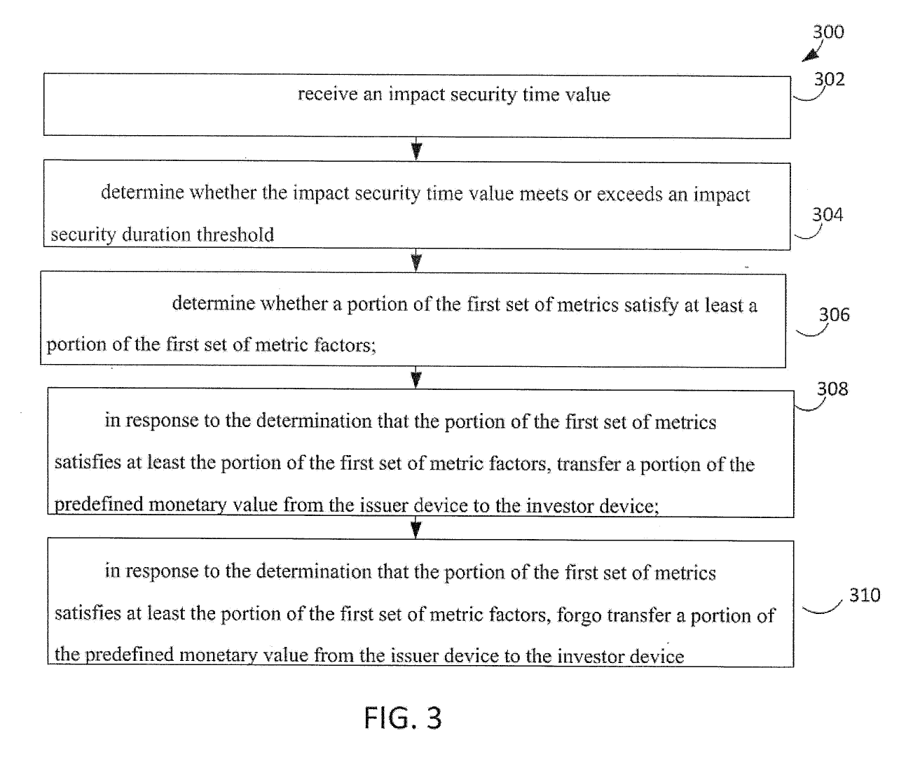

At block 208, method 200 may receive a second set of metric factors associated with impact security from a third party researcher device. For instance, impact security issuer device 110 (FIG. 1) may be configured to execute the receiving component/module to receive a second set of metric factors associated with impact security 150 (FIG. 1) from a third party researcher device 160 (FIG. 1). In some aspects, method 200 may proceed to block 302 (FIG. 3) following block 208, and may return to block 210 from block 304 (FIG. 1).

At block 210, method 200 may determine whether the second set of metric factors satisfy the first set of metric factors. For example, impact security issuer device 110 (FIG. 1) may be configured to execute determination component/module to determine whether the second set of metric factors satisfy the first set of metric factors.

Method 200 may proceed to block 212 when a determination is made that the second set of metric factors satisfies the first set of metric factors. Specifically, at block 212, method 200 may transfer a predefined monetary value from the issuer device to the investor device. For instance, impact security issuer device 110 (FIG. 1) may be configured to execute security transfer/trading component/module to transfer a predefined monetary value from the impact security issuer device 110 (FIG. 1) to the investor device 120 (FIG. 1).

In some aspects, method 200 may proceed to block 214 when a determination is made that the second set of metric factors does not satisfy the first set of metric factors. In particular, at block 214, method 200 may forgo transfer of the predefined monetary value from the issuer device to the investor device. For example, impact security issuer device 110 (FIG. 1) may be configured to forgo transfer of the predefined monetary value from the impact security issuer device 110 (FIG. 1) to the investor device 120 (FIG. 1).

FIG. 3 illustrates example method and/or process 300 of creating, trading, and/or managing an impact security in accordance with the present aspects. In some aspects, method 300 may be executed on or as part of impact security issuer device 110 (FIG. 1), which may include one or more processing components and a database. In some aspects, method 300 may begin or otherwise continue from block 208 (FIG. 2).

At block 302, method 300 may receive an impact time value. For example, impact security issuer device 110 (FIG. 1) may be configured to execute a timer to receive an impact security time value. At block 304, method 300 may determine whether the impact security time value meets or exceeds an impact security duration threshold. For instance, impact security issuer device 110 (FIG. 1) may be configured to execute a determination component/module to determine whether the impact security time value meets or exceeds an impact security duration threshold.

In some aspects, method 300 may proceed to block 210 (FIG. 2) based on a determination that the impact security time value does not meet or exceed the impact security duration threshold. Otherwise, method 300 may proceed to block 306 based on a determination that the impact security time value meets or exceeds the impact security duration threshold.

At block 306, method 300 may determine whether a portion of the second set of metric factors satisfy at least a portion of the first set of metric factors. For instance, impact security issuer device 110 (FIG. 1) may be configured to execute a determination component/module to determine whether a portion of the second set of metric factors satisfy at least a portion of the first set of metric factors.

Method 300 may proceed to block 308 based on a determination that the portion of the second set of metric factors satisfies at least the portion of the first set of metric factors. Otherwise, method 300 may proceed to block 310 based on a determination that the portion of the second set of metric factors does not satisfy at least the portion of the first set of metric factors.

Specifically, at block 308, method 300 may transfer a portion of the predefined monetary value from the issuer device to the investor device. For instance, impact security issuer device 110 (FIG. 1) may be configured to execute security transfer/trading component/module to transfer a portion of the predefined monetary value from the impact security issuer device 110 (FIG. 1) to the investor device 120 (FIG. 1).

Conversely, at block 310, method 300 may forgo transfer of the portion of the predefined monetary value from the issuer device to the investor device. For example, impact security issuer device 110 (FIG. 1) may be configured to forgo transfer of the portion of the predefined monetary value from the impact security issuer device 110 (FIG. 1) to the investor device 120 (FIG. 1).

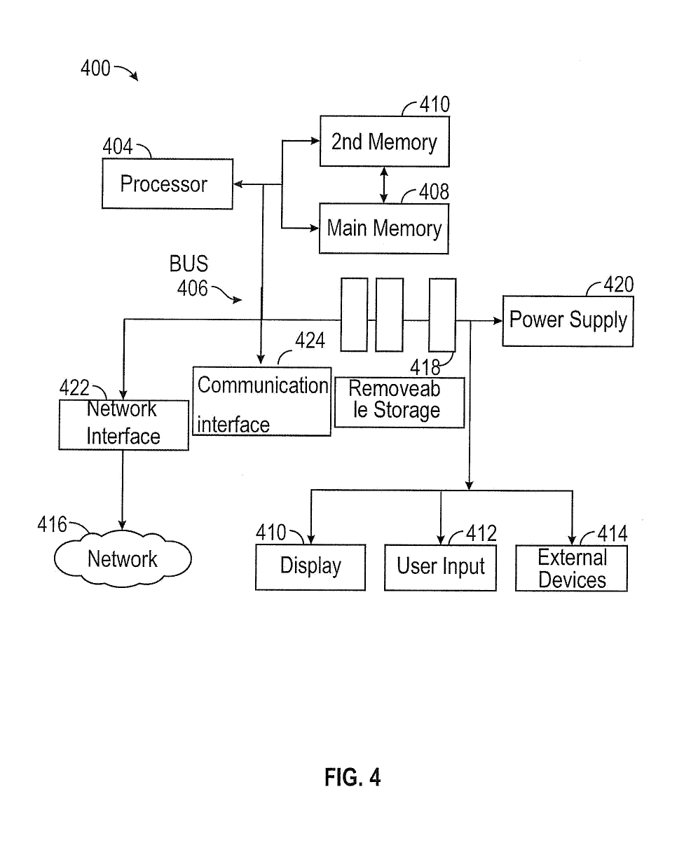

Referring to FIG. 4, an example computer system 400 is illustrated in which the present aspects may be implemented by software, firmware, hardware, or a combination thereof. Specifically, FIG. 4 illustrates an example computer system 400 in which the present aspects, or portions thereof, may be implemented as computer-readable code/instructions. For example, the method illustrated by flowcharts 300 of FIG. 3 may be implemented in system 400. Further, one or more of the devices and/or entities illustrated in FIGS. 1 and 2 may be implemented in or as part of system 400. Various aspects are described in terms of this example computer system 400.

In some aspects, computer system 400 includes one or more processors, such as processor 404. Processor 404 may be a special purpose or a general purpose processor. Processor 404 may be connected to a communication infrastructure 406 (for example, a bus or network).

Computer system 400 may also include a main memory 408, preferably random access memory (RAM), and may also include a secondary memory 410. Secondary memory 410 may include, for example, a hard disk drive 412, a removable storage drive 414, and/or a memory stick. Removable storage drive 414 may include a floppy disk drive, a magnetic tape drive, an optical disk drive, and/or a flash memory. The removable storage drive 414 reads from and/or writes to a removable storage unit 418. Removable storage unit 418 may include, for example, a floppy disk, magnetic tape, and/or optical disk that is read by and written to by removable storage drive 414. Removable storage unit 418 may include a computer usable storage medium having stored therein computer software and/or data.

In some aspects, secondary memory 410 may include other similar means for allowing computer programs or other instructions to be loaded into computer system 400. Such means may include, for example, a removable storage unit 422 and an interface 420. Examples of such means may include a program cartridge and cartridge interface, a removable memory chip (such as an EPROM, or PROM) and associated socket, and other removable storage units 422 and interfaces 420 that allow software and data to be transferred from the removable storage unit 422 to computer system 400.

Further, computer system 400 may also include a communications interface 424. Communications interface 424 allows software and data to be transferred between computer system 400 and external devices. Communications interface 424 may include, for example, a wired and/or wireless modem, a network interface (such as an Ethernet card), a communications port, a PCMCIA slot and card. Software and data transferred via communications interface 424 are in the form of signals that may be electronic, electromagnetic, optical, or other signals capable of being received by communications interface 424. These signals are provided to communications interface 424 via a communications path 1026. Communications path 426 carries signals and may be implemented using wire or cable, fiber optics, a phone line, a cellular phone link, an RF link or other communications channels.

One or both of main memory 408 or secondary memory 410 may include one or more computer-readable storage mediums. In some aspects, the computer-readable storage mediums may be tangible and non-transitory. The computer-readable storage mediums may generally refer to media such as removable storage unit 418, removable storage unit 422, and a hard disk installed in hard disk drive 412. Signals carried over communications path 426 can also embody the logic described herein. In some aspects, these computer program products are means for providing software to computer system 400.

Computer programs (also called computer control logic) may be stored in main memory 408 and/or secondary memory 410. Computer programs may also be received via communications interface 424. Such computer programs, when executed, enable computer system 400 to implement the present aspects as disclosed herein. In particular, the computer programs, when executed, enable processor 404 to implement the processes of the present aspects, such as the steps in the methods illustrated by flowchart 300 of FIG. 3, discussed herein. Accordingly, such computer programs represent controllers of the computer system 400. Where the present aspects are implemented using software, the software may be stored in a computer program product and/or computer-readable storage medium and loaded into computer system 400 using removable storage drive 414, interface 420, hard drive 412 or communications interface 424.

Aspects of the invention are also directed to computer program products including software stored on any computer-readable storage medium. Such software, when executed in one or more data processing device, causes a data processing device(s) to operate as described herein. The present aspects employ any computer-readable storage medium, known now or in the future. Examples of computer-readable storage mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.).

1. A method, comprising:
at an issuing device including one or more processing components:
generating an impact security, wherein the impact security includes a first set of metric factors;
receiving an acquisition request to acquire the impact security from an investor device;
transferring the impact security to one or both of the investor device or a change agent entity in response to receiving the request to acquire the impact security by the investor device;
receiving a second set of metric factors associated with the impact security from a third party researcher device;
determining whether the second set of metric factors satisfy the first set of metric factors; and
transferring a predefined monetary value from the issuer device to the investor device based on a determination that the second set of metric factors satisfy the first set of metric factors.

2. The method of claim 1, wherein the first set and second set of metric factors include one or more of a target group, a geographic location, an impact direction indication, or an impact number.

3. The method of claim 2, wherein the impact number is a percentage value associated with one or more of the target group, the geographic location, or the impact direction indication.

4. The method of claim 1, wherein the first set of metric factors includes a first impact number corresponding to a threshold percentage value of a target characteristic and the second set of metric factors includes a second impact number corresponding to a measured percentage value of the target characteristic.

5. The method of claim 4, wherein determining whether the second set of metric factors satisfy the first set of metric factors includes determining whether the second impact number corresponding to the measured percentage value meets or exceeds the first impact number corresponding to the threshold percentage value.

6. The method of claim 1, further comprising forgoing transfer of the predefined monetary value from the issuer device to the investor device based on a determination that the second set of metric factors does not satisfy the first set of metric factors.

7. The method of claim 1, wherein receiving the second set of metric factors includes receiving the second set of metric factors on a periodic basis.

8. The method of claim 1, wherein the impact security is associated with the change agent entity.

9. An electronic device, comprising:
one or more processors;
memory;
one or more programs stored in memory, the one or more programs including instructions for:
generating an impact security, wherein the impact security includes a first set of metric factors;
receiving an acquisition request to acquire the impact security from an investor device;
transferring the impact security to one or both of the investor device or a change agent entity in response to receiving the request to acquire the impact security by the investor device;
receiving a second set of metric factors associated with the impact security from a third party researcher device;
determining whether the second set of metric factors satisfy the first set of metric factors; and
transferring a predefined monetary value from the issuer device to the investor device based on a determination that the second set of metric factors satisfy the first set of metric factors.

10. The electronic device of claim 9, wherein the first set and second set of metric factors include one or more of a target group, a geographic location, an impact direction indication, or an impact number.

11. The electronic device of claim 10, wherein the impact number is a percentage value associated with one or more of the target group, the geographic location, or the impact direction indication.

12. The electronic device of claim 9, wherein the first set of metric factors includes a first impact number corresponding to a threshold percentage value of a target characteristic and the second set of metric factors includes a second impact number corresponding to a measured percentage value of the target characteristic.

13. The electronic device of claim 12, wherein determining whether the second set of metric factors satisfy the first set of metric factors includes determining whether the second impact number corresponding to the measured percentage value meets or exceeds the first impact number corresponding to the threshold percentage value.

14. The electronic device of claim 9, wherein the one or more programs further include instructions for forgoing transfer of the predefined monetary value from the issuer device to the investor device based on a determination that the second set of metric factors does not satisfy the first set of metric factors.

15. A computer-readable storage medium comprising one or more programs for execution by one or more processors of an electronic device, the one or more programs including instructions which, when executed by the one or more processors, cause the electronic device to:
generate an impact security, wherein the impact security includes a first set of metric factors;
receive an acquisition request to acquire the impact security from an investor device;
transfer the impact security to one or both of the investor device or a change agent entity in response to receiving the request to acquire the impact security by the investor device;
receive a second set of metric factors associated with the impact security from a third party researcher device;
determine whether the second set of metric factors satisfy the first set of metric factors; and
transfer a predefined monetary value from the issuer device to the investor device based on a determination that the second set of metric factors satisfy the first set of metric factors.

16. The computer-readable storage medium of claim 15, wherein the first set and second set of metric factors include one or more of a target group, a geographic location, an impact direction indication, or an impact number.

17. The computer-readable storage medium of claim 16, wherein the impact number is a percentage value associated with one or more of the target group, the geographic location, or the impact direction indication.

18. The computer-readable storage medium of claim 15, wherein the first set of metric factors includes a first impact number corresponding to a threshold percentage value of a target characteristic and the second set of metric factors includes a second impact number corresponding to a measured percentage value of the target characteristic.

19. The computer-readable storage medium of claim 18, wherein determining whether the second set of metric factors satisfy the first set of metric factors includes determining whether the second impact number corresponding to the measured percentage value meets or exceeds the first impact number corresponding to the threshold percentage value.

20. The computer-readable storage medium of claim 15, further comprising instructions which, when executed by the one or more processors, cause the electronic device to forgo transfer of the predefined monetary value from the issuer device to the investor device based on a determination that the second set of metric factors does not satisfy the first set of metric factors.
